(19) United States
(12) Patent Application Publication
(10) Pub. No.: US 2006/0010385 A1
(43) Pub. Date: Jan. 12, 2006

(54) Electronic device, tuning system and channel-setting program

(75) Inventor: Noriyuki Sasaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/226,492

(22) Filed: Sep. 14, 2005

Related U.S. Application Data
(63) Continuation of application No. PCT/JP03/05535, filed on Apr. 30, 2003.

(51) Int. Cl. H04N 11/00; G11B 27/00

(52) U.S. Cl. 715/718; 348/552

(57) ABSTRACT

An electronic device, a tuning system and a channel-setting program are provided wherein, in the case where first and second electronic devices connected to transmit or receive at least the video signal each have a TV tuner and a channel-setting function and in the case where the TV channel is set in one of the electronic devices, then the result of setting the TV channel is set in the electronic device that has set the channel while at the same time being transferred to and set in the electronic device that has not set the channel, so that the channel can be set for the two electronic devices at the same time. The two electronic devices are, for example, the main unit of a personal computer and a display connected thereto, or a television set and a recorder connected thereto.

This application is a continuation application based upon International application No. PCT/JP03/05535, filed on Apr. 30, 2003, the contents being incorporated herein by reference.

### TECHNICAL FIELD

This invention relates to an electronic device, a tuning system and a channel-setting program, or in particular to an electronic device, a tuning system and a channel-setting program in which the channels of two tuners, such as TV tuners built in two electronic devices connected to each other, can be set by a single operating unit.

More specifically, the invention relates to an electronic device, a tuning system and a channel-setting program, in which the channels of a display having a TV tuner built therein and a personal computer having a TV tuner built therein, or the channels of the TV tuners built in a TV set and a recorder such as a video cassette recorder (hereinafter referred to as VCR), a digital versatile disk (hereinafter referred to as DVD) or a hard disk drive connected to the TV set can set with a single remote controller.

### BACKGROUND ART

In recent years, more and more personal computers carry a TV tuner, and the personal computers are used as TVs. The reason is that the storage capacity of the hard disk drive making up a storage medium mounted on the personal computer has increased so remarkably that TV programs can now be recorded in the hard disk drive of the personal computer.

In the personal computer carrying the TV tuner, the TV tuner is generally mounted on the main unit of the personal computer but not on the display. The reason is that a TV program can be recorded more easily on the hard disk drive, in the case where the TV tuner is incorporated in the main unit of the personal computer, than otherwise. Another reason is that in the case where the TV tuner is mounted only on the display, the image data is transmitted from the display to the main unit of the personal computer at a higher circuit cost.

To view a TV program on the personal computer with the TV tuner mounted on the main unit thereof, both the OS (operating system) of the personal computer and the application software for activating the TV functions must be started. This operation is bothersome, on the one hand, and a considerable length of time is required from the turning on of the power supply of the personal computer until the TV screen actually becomes visible on the display, on the other hand.

In view of this, a personal computer has become available in which the TV tuner is mounted on both the main unit of the personal computer and the display connected thereto. This personal computer, like the ordinary TV set, is so convenient that a TV program can be readily viewed simply by turning on the power of the display.

In the personal computer with the TV tuner mounted on both the main unit and the display, however, the channel setting may be different between the TV tuner on the main unit of the personal computer and the TV tuner on the display due to the difference in the setting algorithm or the receiving sensitivity of the tuner unit. This difference in channel setting occurs in the case where the radio wave of the receiving station is weak or the user manually sets a free channel to another channel as he/she desires.

In the case where the channel is differently set by the two TV tuners on the main unit of the personal computer and the display as described above and the channel is changed by a single remote controller, the broadcast stations assigned to the ten-keys of the single remote controller or the arrangement of the broadcast stations on the remote controller used to change the channels may be different. As a result, the user changing the channels may be inconvenienced. Also, in the case where the same channel is being viewed on the display screen and is recorded in the main unit of the personal computer, a program of a different channel may be recorded.

These problems may be encountered also in the case where two TV tuners are mounted independently of each other on two electronic devices connected to each other to transmit or receive the video signal, or for example, in the case where one or a plurality of recorders such as a VCR, a DVD recorder or a hard disk drive are connected to a TV set.

### DISCLOSURE OF THE INVENTION

Accordingly, it is an object of this invention to provide an electronic device, a tuning system and a channel-setting program in which, in the case where two tuners are mounted independently of each on two electronic devices connected to transmit or receive the video signal, the receiving channel set by the tuner of one of the electronic devices is automatically transferred to the tuner of the other electronic device so that the same receiving channel can be set in the two tuners.

In order to achieve this object, there is provided an electronic device according to a first aspect of the invention connected to an external device, comprising a tuner adapted to be tuned to a plurality of frequencies, a recorder for recording the channel-setting data indicating the correspondence between the tuned frequency of the tuner and the office number and a setting data write circuit for recording the data transmitted from the external device as a channel-setting data.

Also, in order to achieve the above-mentioned object, there is provided an electronic device according to a second aspect of the invention connected to an external device, comprising a tuner adapted to be tuned to a plurality of frequencies, channel-setting data indicating the correspondence between the tuned frequency of the tuner and the office number and a setting data read circuit for transmitting the channel-setting data to the external device.

Further, in order to achieve the above-mentioned object, according to this invention, there is provided a tuning system comprising a first electronic device having a first tuner, a second electronic device connected to the first electronic device and having a second tuner, a first recorder for recording the first channel-setting data indicating the correspondence between the tuned frequency of the first tuner of the first electronic device and the office number, a second recorder for recording the second channel-setting data indicating the correspondence between the tuned frequency of the second tuner of the second electronic device and the channel number, a setting-data read circuit included in the first electronic device to transmit the first channel-setting data to the second electronic device, and a setting-data write circuit included in the second electronic device whereby the first channel-setting data transmitted from the setting-data read circuit is recorded as the second channel-setting data of the second recorder included in the second electronic device.

On the other hand, in order to achieve the above-mentioned object, there is provided a channel-setting program according to a first aspect of this invention, for an electronic device connected to an external device, comprising a tuner adapted to be tuned to a plurality of frequencies, a storage unit for storing the channel-setting data indicating the correspondence between the tuned frequency of the tuner and the office number and a controller, wherein the controller is operated as a means to record the data transmitted from the external device as the channel-setting data of the storage unit.

Furthermore, in order to achieve the above-mentioned object, there is provided a channel-setting program according to a second aspect of this invention, for an electronic device connected to an external device, comprising a tuner adapted to be tuned to a plurality of frequencies, a storage unit for storing the channel-setting data indicating the correspondence between the tuned frequency of the tuner and the office number and a controller, wherein the controller is operated as a means to read from the storage unit the channel-setting data transmitted to the external device.

In the electronic device, the tuning system and the channel-setting program according to this invention, two tuners are mounted independently of each other on two electronic devices connected to transmit or receive the video signal. The receiving channel set by the tuner of one of the electronic devices is automatically transferred to the tuner of the other electronic device so that the same receiving channel is set by the two tuners.

If two TV tuners are mounted independently of each other on two electronic devices including a display and connected to transmit or receive the video signal, in the case where the TV channel is set by the TV tuner of one of the electronic devices using the buttons on the remote controller or the main unit, the same TV channel is automatically set by the TV tuner of the other electronic device. As a result, the same channel can be set on the two TV tuners by a simple operation, and therefore the recording error which otherwise might be caused by the channel difference is conveniently prevented at the time of recording.

### BRIEF DESCRIPTION OF THE DRAWINGS

The above and other objects, features and advantages will be described in detail below with reference to the embodiments shown in the accompanying drawings, in which:

FIG. 1 is a perspective view showing a configuration of a personal computer constituting an electronic device according to an embodiment of the invention;

FIG. 2 is a block circuit diagram showing the internal configuration of the personal computer of FIG. 1;

FIG. 3A is a block diagram showing an example of the functional configuration of the electronic device according to the invention;

FIG. 3B is a block diagram showing another example of the functional configuration of the electronic device according to the invention;

FIG. 4 is a flowchart showing the steps of setting a channel on the main unit of a personal computer and transferring the channel thus set to the display in an application of the method of setting a TV channel in an electronic device with a TV tuner built in both the display and the main unit thereof according to the invention;

FIG. 5 is a flowchart showing the steps of setting a TV channel on the display by the channel-setting method described in FIG. 4;

FIG. 6 is a table showing the contents of the TV channel set on the display by the channel-setting method according to the invention;

FIG. 7 is a table showing the contents of the TV channel set on the main unit of the personal computer by the channel-setting method according to the invention;

FIG. 8 is a flowchart showing the steps of setting a channel on the display of a personal computer with a TV tuner built in both the display and the main unit thereof and transferring the channel thus set to the main unit of the personal computer in an application of the method of setting a channel in an electronic device according to the invention;

FIG. 9 is a flowchart showing the steps of setting a TV channel on the main unit of the personal computer by the channel-setting method described in FIG. 8;

FIGS. 10A to 10C show video signals of the personal computer, of which FIG. 10A is a waveform diagram showing the waveform of the vertical sync signal sent to the display having the function to display the TV image, FIG. 10B a waveform diagram showing the waveform of the horizontal sync signal sent to the display having the function to display the TV image, and FIG. 10C a waveform diagram showing the waveform of the RGB signal which is sent to the display having the function to display the TV image and on which the channel-setting data is superposed during the vertical blanking period of the RGB signal; and

FIG. 10D is a waveform diagram showing the waveform of the video signal with the channel-setting data superposed on the television video signal.

### BEST MODE FOR CARRYING OUT THE INVENTION

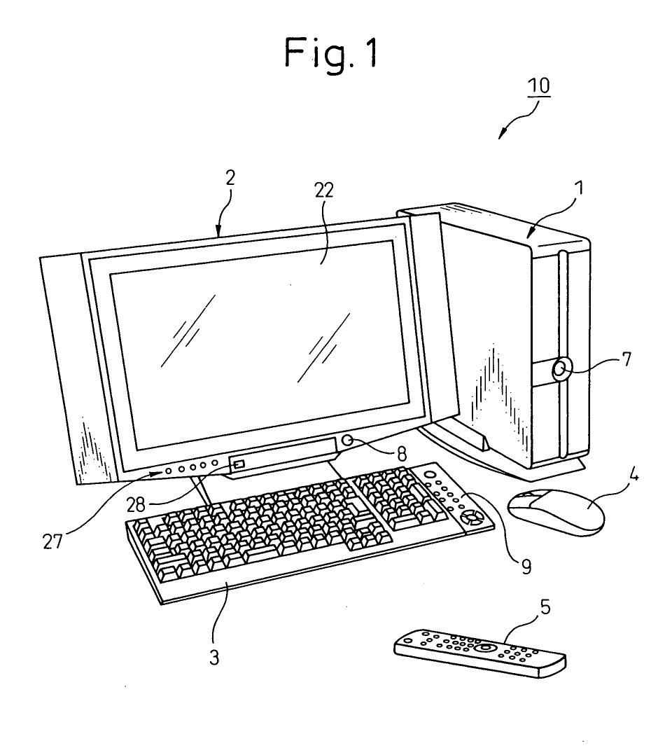

FIG. 1 shows a configuration of a personal computer 10 as an electronic device according to an embodiment of the invention. The personal computer 10 according to this embodiment comprises a main unit 1 of the personal computer (hereinafter referred to as PC), a display 2, a keyboard 3, a mouse and a remote controller 5. The PC 1 has a power button 7, upon depression of which the personal computer 10 is activated. The PC 1 and the display 2 according to this embodiment both have a television tuner (hereinafter referred to as the TV tuner) built therein. The TV tuner of the PC 1 is adapted not to operate unless the PC 1 is turned on, while the TV tuner built in the display 2 is adapted to operate simply by depressing the power button 8 and turning on the display 2.

According to this embodiment, the display 2 is of thin type and has a liquid crystal display panel 22. On the front of the display 2, there are arranged a power button 8 for turning on the display 2 alone, operating buttons 27 for setting or changing the channel and controlling the sound volume, and a light-receiving window 28 for receiving the infrared light signal emitted from a remote controller 5. The keyboard 3 according to this embodiment carries an AV (audio and visual) controller 9 on the right side of the ordinary input key. According to this embodiment, the operation of the CD and the DVD set on the PC 1 can be controlled, the TV tuner can be turned on/off and the sound volume can be controlled using the buttons arranged on the AV controller 9 or the buttons (ten-keys) arranged on the remote controller 5.

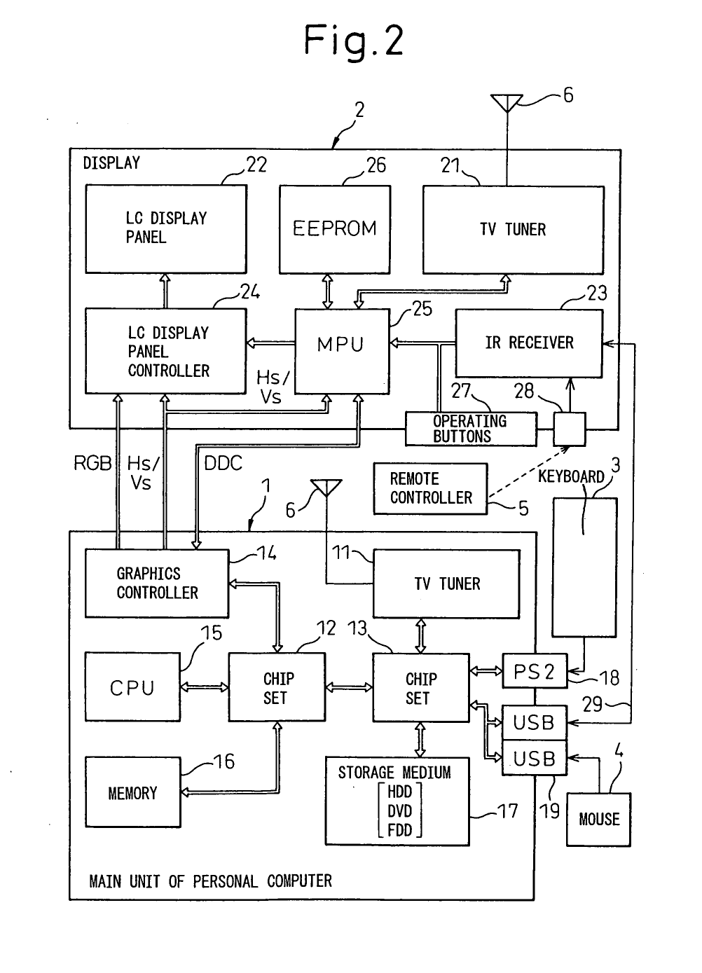

FIG. 2 is a block circuit diagram showing the internal configuration of the personal computer 10 according to an embodiment shown in FIG. 1. In this embodiment, the PC 1 includes a TV tuner 11, chip sets 12, 13, a graphics controller 14, a CPU 15, a memory 16, a storage medium 17, an input port 18 for PS 2 and an input port 19 for USB. These component parts are connected to each other by an internal bus. The display 2, on the other hand, includes a TV tuner 21, a liquid crystal display panel 22, an IR (infrared) receiver 23, a liquid crystal display panel controller 24, a MPU 25, an EEPROM 26, operating buttons 27, and a light-receiving window 28 for receiving the infrared light signal. These component parts are connected to each other through an internal bus.

In the PC 1 according to this embodiment, the video signal input from the antenna 6 to the TV tuner 11 is recorded in the storage unit 17 or sent to the display 2 through the graphics controller 14 under the control of the CPU 15 and the chip sets 12, 13. The storage medium 17 that can be used in this case is a hard disk drive (HDD), a DVD or a floppy disk (FDD).

In setting the channel received by the TV tuner 11 of the PC 1, the keyboard 3 or the mouse 4 connected to the PS 2 input port 18 or the USB input port 19 or the remote controller 5 described later can be used. The channel-setting data of the TV tuner 11 is stored in the memory 16 or the storage medium 17.

In the display 2, on the other hand, the RGB signal input from the graphics controller 14 of the PC 1 is displayed on the liquid crystal display panel 22 based on the horizontal sync signal Hs and the vertical sync signal Vs normally under the control of the liquid crystal display panel controller 24. The RGB signal from the PC 1 is the video signal received by the TV tuner of the PC 1 or the video signal reproduced by the storage medium 17. In the case where the display 2 has the TV tuner 21 as in this embodiment, the liquid crystal display panel controller 24 causes the video signal input from the antenna 6 to the TV tuner 21 to be sent to and displayed on the liquid crystal display panel 22 while the display 2 is in TV mode.

When the display 2 is set to be in the TV mode, it indicates the mode in which a TV program is displayed on the display 2 regardless of whether the PC 1 is on or off. The TV mode is set by depression of the operating buttons 27 or the TV mode button of the remote controller 5. The infrared light signal emitted from the remote controller 5 is input to the light-receiving window 28 of the display 2 and received by the IR receiver 23.

According to this embodiment, the output of the IR receiver 23 of the display 2 is input to the input port 19 for USB of the PC 1 through the USB cable 29. Thus, the TV channel can be set or changed on the PC 1 using the remote controller 5.

In setting the channel received by the TV tuner 21 of the display 2, on the other hand, a predetermined set of the operating buttons 27 on the display 2 are depressed, or the ten-keys are depressed after depressing the channel-setting button of the remote controller 5. According to this embodiment, the channel received by the TV tuner 21 of the display 2 can be set by the USB signal or the DDC (display data channel) signal superposed during the vertical blanking period of the video signal input to the liquid crystal panel controller 24 from the PC 1 or input to the MPU 25 from the PC 1. The channel-setting data of the TV tuner is then stored in the EEPROM 26.

The video signal output from the PC 1 includes the RGB signal constituting the data of each color, the vertical sync signal Vs and the horizontal sync signal Hs described above. Also, the DDC signal is the interface signal for communication with the display 2 to indicate the characteristics of the display 2.

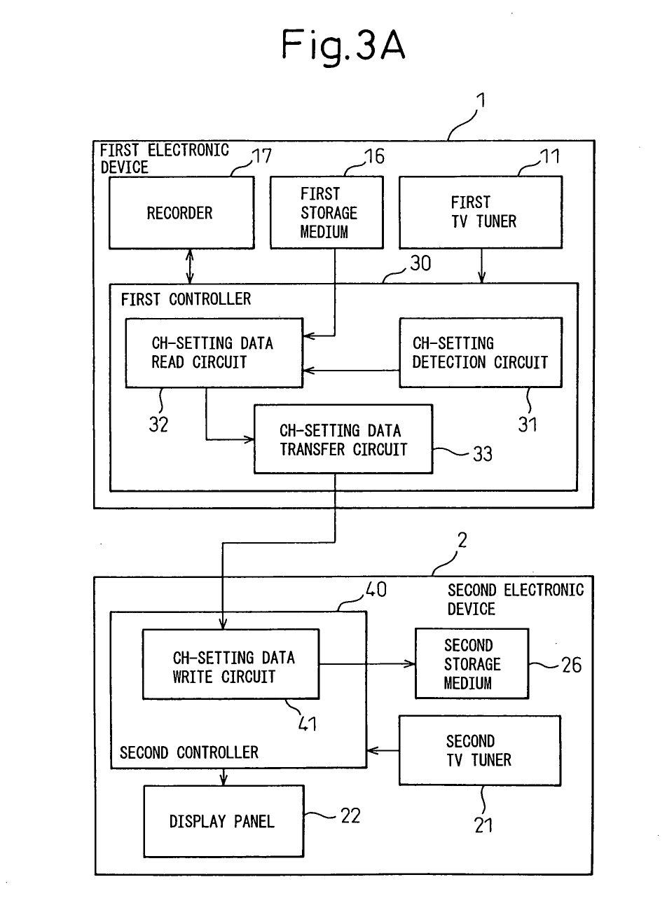

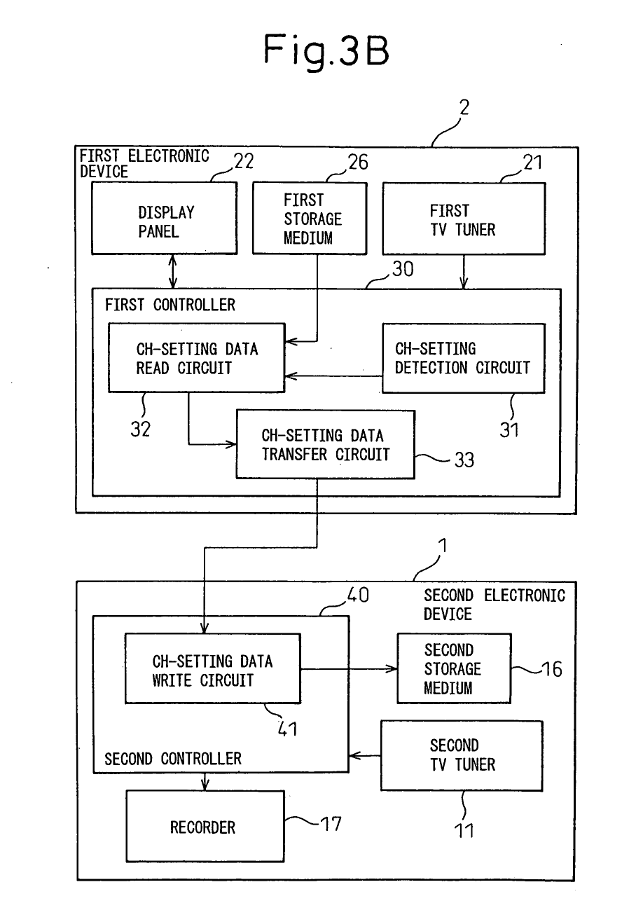

The functional configuration of the electronic device required for transferring the channel setting of the TV tuner executed on the PC 1 of FIG. 2 to the display 2 as a channel setting of the display 2 is explained with reference to FIG. 3A. In FIG. 3A, the first electronic device 1 corresponds to the PC 1 in FIG. 2, and the second electronic device 2 to the display 2 in FIG. 2.

The first electronic device 1 includes a first TV tuner 11, a first storage medium (such as a memory) 16 and a first controller 30 connected to a recorder (such as a HDD) 17. The first controller 30 can be arranged in the CPU 15 or the chip set 12 or 13. The first controller 30 includes therein a channel-setting detection circuit 31, a channel-setting data read circuit 32 and a channel-setting data transfer circuit 33. The channel-setting detection circuit 31 detects whether the channel is set or not in the first electronic device 1, and upon detection of the channel setting, informs the channel-setting data read circuit 32. Then, the channel-setting data read circuit 32 reads the channel-setting data from the recorder 17 (in the case where the PC 1 is a microcomputer) or the first storage medium 16 (in the case where the PC 1 is a television set or VCR) and inputs the data thus read to the channel-setting data transfer circuit 33. The channel-setting data transfer circuit 33 transfers the input channel-setting data to the second electronic device 2.

The second electronic device 2 includes a second TV tuner 21, a second storage medium (such as an EEPROM) 26, and a second controller 40 connected to the display panel 22. The second controller 40 can be arranged in the MPU 25. The second controller 40 has arranged therein a channel-setting data write circuit 41. The channel-setting data write circuit 41 stores the channel-setting data, if transferred from the first electronic device 1, in the second storage medium 26. In the case where the channel-setting data is already written in the second storage medium 26, the channel-setting data transferred to the channel-setting data write circuit 41 is overwritten on the channel-setting data in storage.

As described above, with the electronic device according to this invention, the channel-setting data set in the first electronic device (PC) and stored in the recorder 17 (in the case where the PC 1 is a microcomputer) or the first storage medium 16 (in the case where the PC 1 is a television set or a VCR) is transferred to the second electronic device (display) 2 through a video signal, a DDC signal or a USB signal, and stored in the second storage medium (EEPROM) 26. Subsequently, therefore, the channel-setting data for the fist and second TV tuners 11 and 21 of the first electronic device 1 and the second electronic device 2 remain the same.

In FIG. 3A, the first electronic device 1 is explained as a component part corresponding to the PC 1 shown in FIG. 2 and the second electronic device 2 as a component part corresponding to the display 2 shown in FIG. 2. On the contrary, as shown in FIG. 3B, the first electronic device may be the display 2, and the second electronic device the PC 1. In this case, the first electronic device 2 includes the first TV tuner 21, the first storage medium (such as an EEPROM) 26 and the first controller 30 connected to the display panel 22. The channel-setting operation of the first TV tuner 21 is performed on the display 2, and the channel-setting data is transferred to the second electronic device (PC) 1 through the DDC signal or the USB cable 29.

The second electronic device 1 includes the second TV tuner 11, the second storage medium (such as a memory) 16 and the second controller 40 connected to the recorder (such as a HDD) 17. The second controller 40 has arranged therein the channel-setting data write circuit 41. The channel-setting data write circuit 41 stores the channel-setting data transferred from the first electronic device 2 in the recorder 17 (in the case where the PC 1 is a microcomputer) or the second storage medium 16 (in the case where the PC 1 is a television set or a VCR). In the case where the channel-setting data is already written in the recorder 17 or the second storage medium 16, the channel-setting data transferred to the channel-setting data write circuit 41 is overwritten on the channel-setting data already in store. Subsequently, therefore, the same channel-setting data is stored in the first electronic device (display) 2 and the second electronic device (PC) 1.

Further, the first electronic device 1 may be a VCR and the second electronic device a TV set. In this case, the VCR and the TV set can transmit and receive the RGB signal to and from each other. By superposing the TV channel-setting data set by one of the VCR and the TV set during the vertical blanking period of the video signal, therefore, the TV channel-setting data can be transferred between the VCR and the TV set.

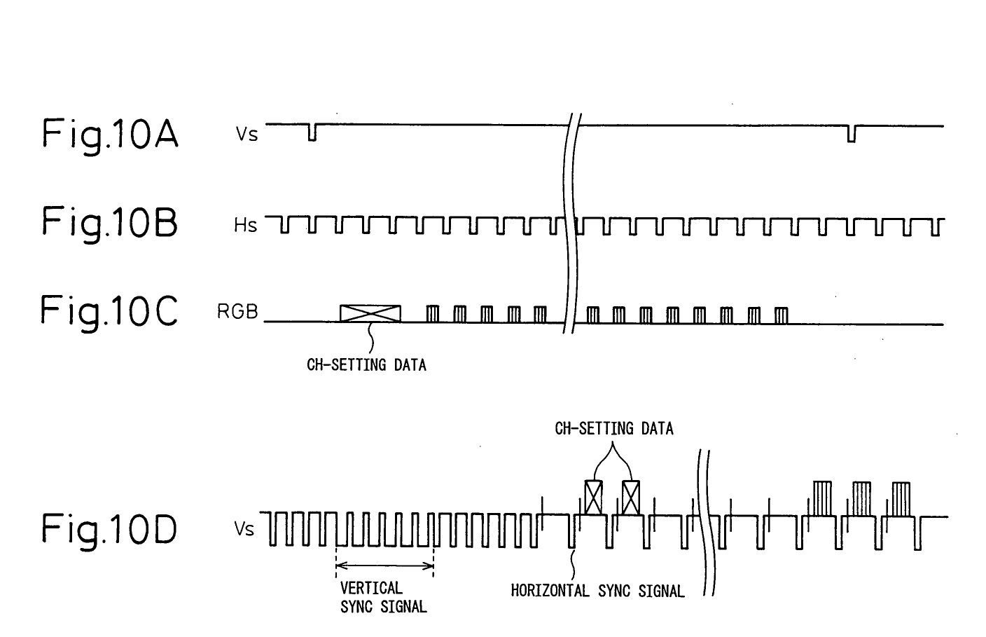

FIGS. 10A to 10C show the video signal for the personal computer. FIG. 10A is a waveform diagram showing the waveform of the vertical sync signal sent to the display having the function to display the TV picture, FIG. 10B a waveform diagram showing the waveform of the horizontal sync signal sent to the display having the function to display the TV picture, and FIG. 10C a waveform diagram showing the waveform of the RGB signal which is sent to the display having the function to display the TV picture and on which the channel-setting data is superposed during the vertical blanking period of the RGB signal. In the case where the channel-setting data is superposed on the video signal of the TV set, on the other hand, the waveform of the video signal is as shown in the waveform diagram of FIG. 10D.

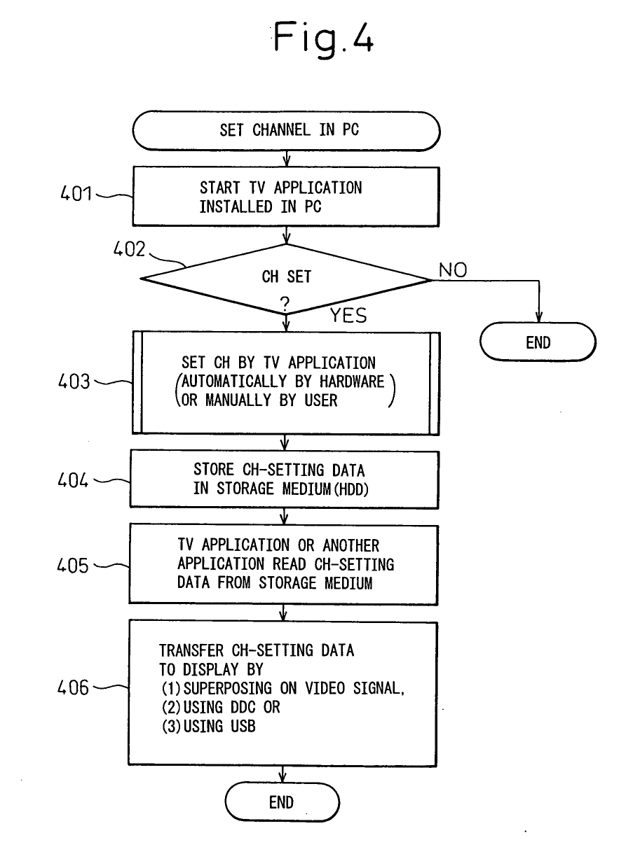

FIG. 4 is a flowchart showing the steps of setting the channel on the PC 1 and transferring the channel thus set to the display 2 in an application to the personal computer 10 having a TV tuner built in both the display 2 and the PC 1 as explained in FIG. 1.

At step 401, first, the TV application installed in the PC 1 is activated. Upon activation of the TV application, the PC 1 can enter the channel-setting mode. At the next step 402, it is determined whether the PC 1 is in channel-setting mode or not (the channel is described as CH in the drawing). In the case where the PC 1 is not in channel-setting mode, this routine is terminated, while in the case where the PC 1 is in channel-setting mode, the process proceeds to step 403.

At step 403 to which the process proceeds upon determination that the PC 1 is in channel-setting mode, the channel is set by this TV application. The channel is set automatically set by the hardware (the channel is automatically searched for and set, or the area number is input and the TV channel unique to the particular area is automatically set), or manually by the user in a free channel as desired. This TV channel-setting method by the TV application is well known and includes various methods which are not described in further detail.

Upon complete channel setting at step 403, the channel-setting data is stored in the storage medium such as the hard disk drive 17 shown in FIG. 2 at step 404. At the next step 405, the TV application or another application reads the channel-setting data from the storage medium.

At the next step 406, the channel-setting data read is transferred to the display 2 by any one of the first to third methods described below and the routine is terminated. In the first method, the channel-setting data is superposed during the vertical blanking period of the video signal. In the second method, the channel-setting data is contained in the DDC signal explained with reference to FIG. 2. In the third method, the channel-setting data is sent using the USB cable also explained with reference to FIG. 2. Any of these methods can be determined in accordance with the configuration of the device for transmitting and receiving the channel-setting data.

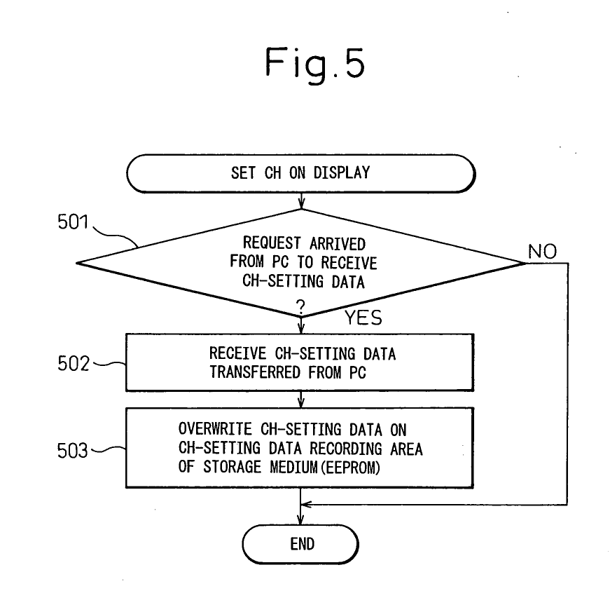

FIG. 5 is a flowchart showing the steps of setting the channel on the display 2 according to the TV channel-setting method explained with reference to FIG. 4. The display 2 monitors whether a request to receive the channel-setting data has arrived or not from the PC 1 at step 501. In the absence of a request to receive the channel-setting data, the routine is ended, while, with the arrival of the request to receive the channel-setting data, the process proceeds to step 502.

At step 502, the channel-setting data transferred from the PC 1 is received, and at the next step 503, the received channel-setting data is stored in the storage medium such as the EEPROM 26 shown in FIG. 2. In the case where the channel-setting data already exists in the channel-setting data storage area in the EEPROM 26, the channel-setting data newly received at step 502 is overwritten on the existing channel-setting data. As a result, the channel-setting data stored in the EEPROM 26 of the display 2 comes to be identical with the channel-setting data stored in the memory 16 of the PC 1.

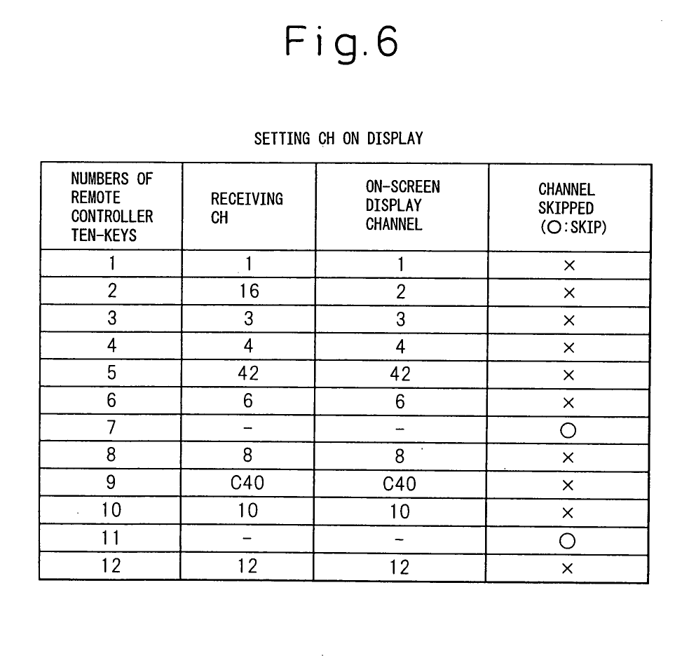

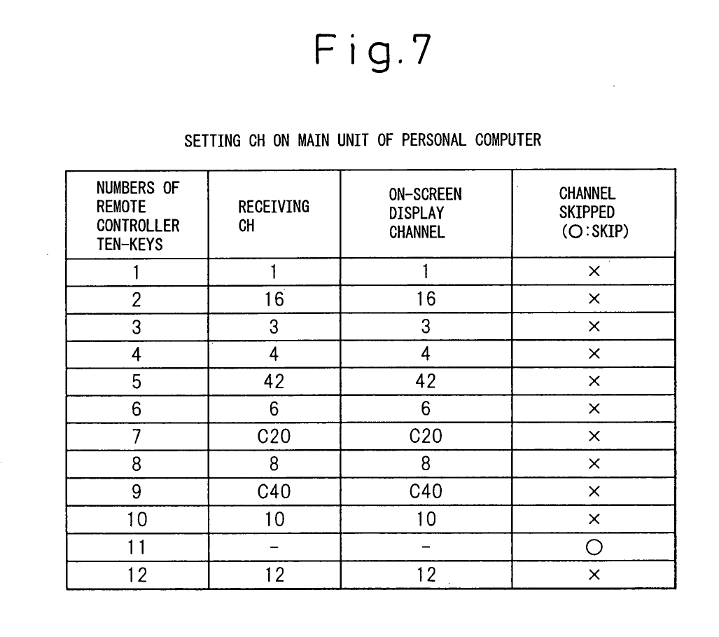

Assume, for example, that the set channel table shown in FIG. 6 is stored in the channel-setting data storage area of the EEPROM 26 of the display 2. In the case where the set channel table shown in FIG. 7 is transferred from the PC 1, the contents of the set channel table shown in FIG. 6 are replaced with the contents of the set channel table shown in FIG. 7.

The embodiment described above deals with the channel-setting steps in the case where the channel set in PC 1 is transferred to the display 2. Next, the channel-setting steps for transferring the channel set by the display 2 to the PC 1 are explained.

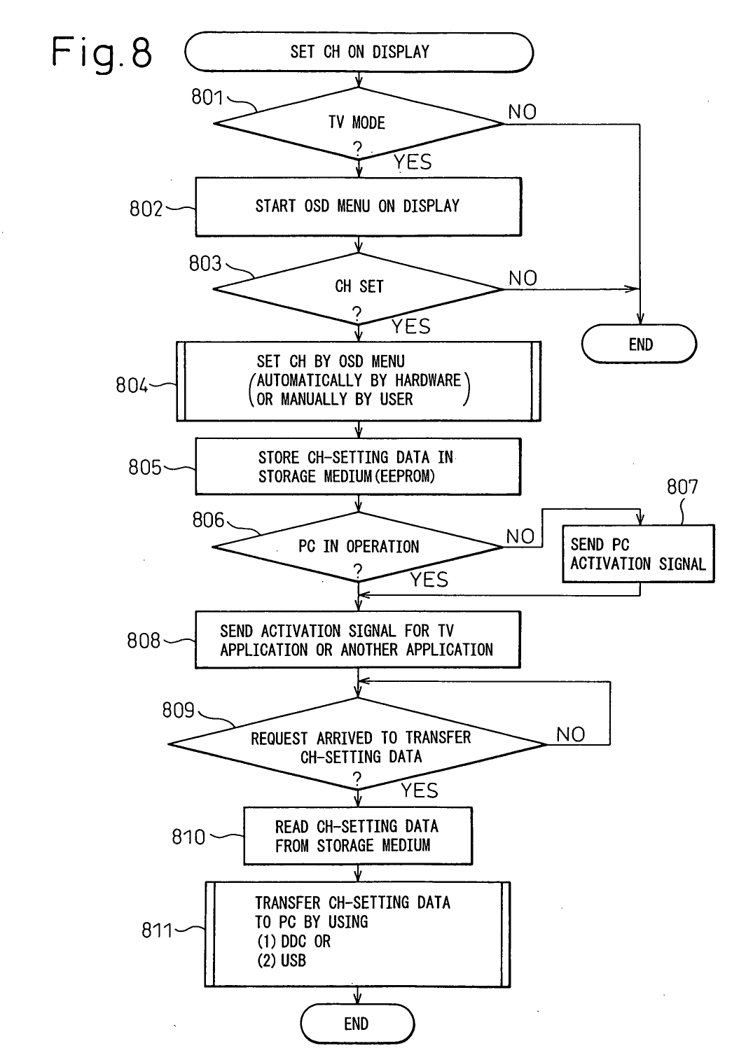

FIG. 8 is a flowchart showing the steps of setting the channel on the display 2 and transferring the channel thus set to the PC 1 in an application, of the TV channel-setting method according to the invention, to the personal computer 10 having a TV tuner built in both the display 2 and the PC 1.

First, at step 801, it is determined whether the display 2 is in TV mode or not. This TV mode can be selected by the operating buttons 27, the AV controller 9 or the remote controller 5 shown in FIG. 1. In the case where the display 2 is not in TV mode, the routine is ended. In the case where the display 2 is in TV mode at step 801, on the other hand, the process proceeds to step 802, where the OSD (on-screen display) menu of the OSD is started. This OSD menu contains a menu that can be opened on the screen of the display 2, and the channel-setting menu is one.

Once the OSD menu is started at step 802, it is determined at step 803 whether the display 2 is in channel-setting mode or not (the channel is referred to as CH). In the case where the display 2 is not in channel-setting mode, the routine is ended, while in the case where the display 2 is in channel-setting mode, the process proceeds to step 804.

At step 804 after determination that the display 2 is in channel-setting mode, the channel-setting menu in the OSD menu is accessed and the channel is set. The channel is set automatically set by the hardware (the receiving channel is automatically searched and set, or the area number is input and the TV channel unique to the particular area is automatically set), or manually by the user in a free channel as desired. This TV channel-setting method by the OSD menu is well known and includes various methods which are not described in further detail.

Upon complete channel-setting operation at step 804, the channel-setting data is stored in the storage medium such as the EEPROM 26 shown in FIG. 2 at step 805. At the next step 806, it is determined whether the PC 1 is in operation or not. In the case where the PC 1 is in operation, the process proceeds directly to step 808, while in the case where the PC 1 is not in operation, the process proceeds to step 807, and after activating the PC 1 by sending the activation signal to the PC 1, proceeds to step 808.

At step 808, the activation signal for the TV application or another application is sent to the PC 1 in operation thereby to activate the TV application or another application installed in the PC 1. At the next step 809, a signal requesting the channel-setting data from the PC 1 is awaited. Upon confirmation that the channel-setting data request signal has arrived from the PC 1, the process proceeds to step 810, and the channel-setting data read circuit 32 reads the channel-setting data from the storage medium (EEPROM).

At the next step 811, the channel-setting data that has been read is transferred to the PC 1 by the first or second method described below and the routine is ended. In the first method, the channel-setting data is contained in the DDC signal explained in FIG. 2. In the second method, the channel-setting data is sent using the USB cable. Any of these methods can be determined in accordance with the configuration of the device for transmitting and receiving the channel-setting data.

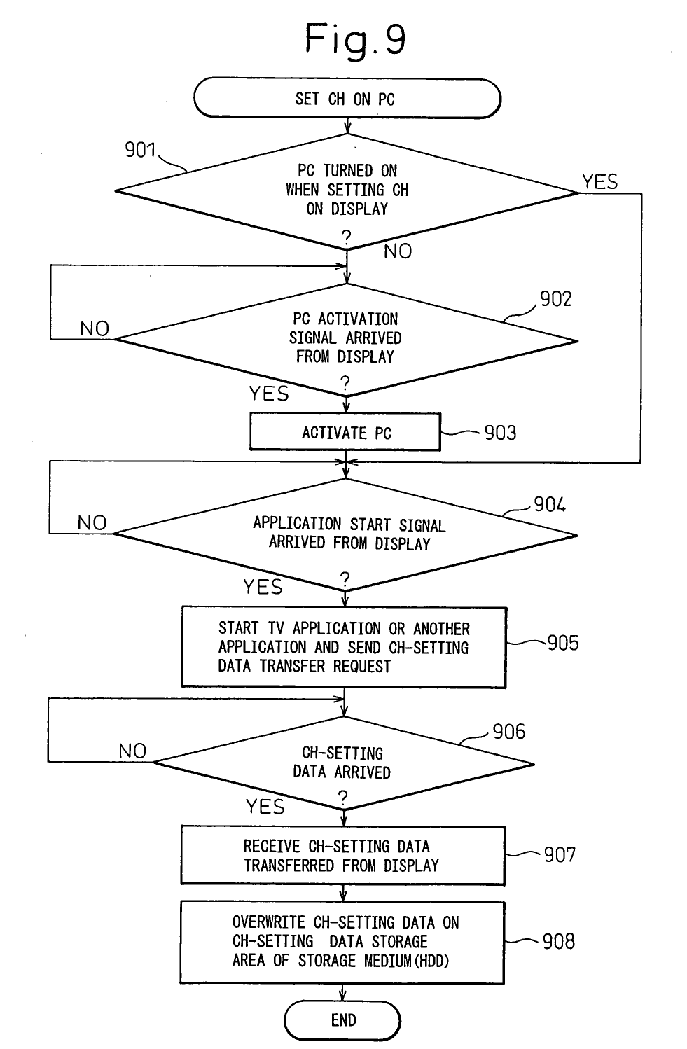

FIG. 9 is a flowchart showing the steps of setting the channel in the PC 1 by the TV channel-setting method described in FIG. 8. At step 901, it is determined whether the PC 1 is turned on when the display 2 sets the channel. In the case where the PC 1 is turned on, the process proceeds to step 904, while in the case where the PC 1 is not turned on, step 902 waits for the arrival of the activation signal for PC 1 from the display 2. With the arrival of the activation signal for the PC 1 from the display 2, the PC 1 is activated at step 903 and the process proceeds to step 904.

Step 904 waits for the arrival of the activation signal for the application from the display 2. In the case where the activation signal for the TV application or another application is sent to the PC 1 in operation at step 808 included in the channel-setting steps of the display 2 described above, the process proceeds from step 904 to step 905. At step 905, the PC 1 activates the TV application or another application installed. Upon activation of the TV application or another application, a request to transfer the channel-setting data is sent to the display 2. After that, step 906 waits for the transfer of the channel-setting data from the display 2.

In response to the channel-setting data transfer request from the PC 1 to the display 2, the display 2 reads the channel-setting data from the storage medium at step 810 included in the channel-setting steps for the display 2 described above, and transfers the channel-setting data to the PC 1 at step 811. Once the channel-setting data begins to be transferred from the display 2 to the PC 1, the process proceeds from step 906 to step 907.

At step 907, the channel-setting data transferred from the display 2 is received and, at the next step 908, the received channel-setting data is stored in the storage medium 17 such as the HDD 17 shown in FIG. 2. In the case where the channel-setting data already exists in the channel-setting data recording area in the HDD 17, the channel-setting data newly received at step 907 is overwritten on the existing channel-setting data. As a result, the channel-setting data stored in the EEPROM 26 of the display 2 comes to coincide with the channel-setting data stored in the storage medium 17, i.e. the HDD 17. Thus, the PC 1 and the display 2 can share the same channel-setting data, and therefore the same operation on the ten-keys of the remote controller 5 is also made possible.

### INDUSTRIAL APPLICABILITY

With the electronic device, the tuning system and the channel-setting program according to this invention, in the case where two TV tuners are mounted independently of each other on two electronic devices connected to transmit or receive a video signal, the TV channel set by the TV tuner of one of the two electronic devices can be automatically transferred to the TV tuner of the other electronic device. Thus, the same channel-setting is made possible on the two TV tuners, and therefore the TV channel-setting operation is facilitated. At the same time, even in the case where the channel is changed by a single remote controller, the two electronic devices always receive the same TV channel, and therefore the user is not inconvenienced. As a result, a recording error is prevented in which a program of an undesired channel, different from the channel set on the main unit of the personal computer, is recorded.

1. An electronic device connected to an external device, comprising:
a tuner adapted to be tuned to a plurality of frequencies;
a recording unit recording the channel-setting data indicating the correspondence between the tuning frequency of the tuner and the office number; and
a setting data write circuit recording the data transmitted from the external device as the channel-setting data.

2. An electronic device according to claim 1, further comprising:
an infrared light-receiving unit,
wherein the tuned frequency of the tuner is changed by the infrared light signal emitted from the operating unit having the ten-keys.

3. An electronic device according to claim 1, further comprising:
a button-type input unit,
wherein the tuned frequency of the tuner is changed by operating the button-type input unit.

4. An electronic device according to claim 1, further comprising:
a keyboard,
wherein the tuned frequency of the tuner is changed by operating the keyboard.

5. An electronic device according to claim 1, further comprising:
a mouse,
wherein the tuned frequency of the tuner is changed by operating the mouse.

6. An electronic device according to claim 1, comprising: a display unit.

7. An electronic device according to claim 1,
wherein the electronic device is an information processing system.

8. An electronic device according to claim 6,
wherein the electronic device receives the video signal from the external device, and
the signal superposed during the vertical blanking period of the video signal is received as data transmitted from the external device.

9. An electronic device according to claim 6,
wherein the external device is an information processing system proper, and the electronic device is a display unit.

10. An electronic device according to claim 6,
wherein the external device is a recorder, and the electronic device is a television set.

11. An electronic device according to claim 6,
wherein the electronic device receives the video signal from the external device, and the signal transmitted through a communication path including the DDC interface and/or the USB interface connecting the external device and the electronic device is received as a data transmitted from the external device.

12. An electronic device according to claim 1,
wherein in the case where the channel-setting data is recorded by the setting data write circuit while the channel-setting data is already recorded in the recording unit, the new channel-setting data is overwritten on the setting data already recorded.

13. An electronic device comprising:
a tuner adapted to be tuned to a plurality of frequencies;
a storage unit recording the channel-setting data indicating the correspondence between the tuned frequency of the tuner and the office number; and
a setting data read circuit transmitting the channel-setting data to the external device.

14. An electronic device according to claim 13, further comprising:
an infrared light-receiving unit,
wherein the tuned frequency of the tuner is changed by the infrared light signal emitted from the operating unit having ten keys.

15. An electronic device according to claim 13, further comprising:
a button-type input unit,
wherein the tuned frequency of the tuner is changed by operating the button-type input unit.

16. An electronic device according to claim 13, further comprising:
a keyboard,
wherein the tuned frequency of the tuner is changed by operating the keyboard.

17. An electronic device according to claim 13, further comprising:
a mouse,
wherein the tuned frequency of the tuner is changed by operating the mouse.

18. An electronic device according to claim 13, comprising: a display unit.

19. An electronic device according to claim 13,
wherein the electronic device is an information processing system.

20. An electronic device according to claim 18,
wherein the electronic device receives the video signal from the external device, and
the signal superposed during the vertical blanking period of the video signal is received as the channel-setting data transmitted from the external device.

21. An electronic device according to claim 18,
wherein the external device is an information processing system proper, and
the electronic device is a display unit.

22. An electronic device according to claim 18,
wherein the external device is a recorder, and
the electronic device is a television set.

23. An electronic device according to claim 18,
wherein the electronic device transmits the video signal from the external device, and
the signal transmitted through a communication path including the DDC interface, the USB interface or both the DDC interface and the USB interface connecting the external device and the electronic device is received as the channel-setting data transmitted from the external device.

24. An electronic device according to claim 13,
wherein in the case where the channel-setting data is recorded by the setting data write circuit while the channel-setting data is already recorded in the electronic device, the new channel-setting data is overwritten on the setting data already recorded.

25. A tuning system comprising:
a first electronic device having a first tuner;
a second electronic device connected to the first electronic device and having a second tuner;
a first recorder recording the first channel-setting data indicating the correspondence between the tuned frequency of the first tuner of the first electronic device and the office number;
a second recorder recording the second channel-setting data indicating the correspondence between the tuned frequency of the second tuner and the second electronic device and the office number;
a setting data read circuit included in the first electronic device to transmit the first channel-setting data to the second electronic device; and
a setting data write circuit included in the second electronic device, whereby the first channel-setting data transmitted from the setting data read circuit is recorded as the second channel-setting data of the second recorder included in the second electronic device.

26. A channel-setting program for an electronic device connected to an external device and characterized by including a tuner adapted to be tuned to a plurality of frequencies, a channel-setting data storage unit indicating the correspondence between the tuned frequency of the tuner and the office number and a controller,
wherein the controller is operated as a means whereby the data transmitted from the external device is recorded as the channel-setting data of the storage unit.

27. A channel setting program for an electronic device connected to an external device and characterized by including a tuner adapted to be tuned to a plurality of frequencies, a channel-setting data storage unit indicating the correspondence between the office number and the tuned frequency of the tuner and a controller,
wherein the controller is operated as a means whereby the channel-setting data transmitted to the external device is read from the storage unit.
